(19) United States
(12) Patent Application Publication
(10) Pub. No.: US 2013/0111378 A1
(43) Pub. Date: May 2, 2013

(54) PORTABLE ELECTRONIC DEVICE, ASSOCIATED APPARATUS AND METHODS

(71) Applicants: John-Rhys Newman, Woodland Hills, CA (US); Pascal Wever, Los Angeles, CA (US); Marco Paglia, San Francisco, CA (US); Duncan Burns, Santa Monica, CA (US); Julian Bleecker, Los Angeles, CA (US); Jacob Zukerman, San Francisco, CA (US)

(72) Inventors: John-Rhys Newman, Woodland Hills, CA (US); Pascal Wever, Los Angeles, CA (US); Marco Paglia, San Francisco, CA (US); Duncan Burns, Santa Monica, CA (US); Julian Bleecker, Los Angeles, CA (US); Jacob Zukerman, San Francisco, CA (US)

(73) Assignee: NOKIA CORPORATION, Espoo (FI)

(21) Appl. No.: 13/285,714

(22) Filed: Oct. 31, 2011

(51) Int. Cl. G06F 3/048

(52) U.S. Cl. 715/764

(57) ABSTRACT

A portable electronic device with first and second modes,
the first mode, associated with allowing for the availability of one or more of a first level of power consumption and processor activity for the portable electronic device, and allowing general unlocked user interaction with the user interface of the portable electronic device;
the second mode, associated with allowing for the availability of one or more of a second level of power consumption or processor activity, and allowing locked user interaction with the user interface; and
the locked user interaction allowing for the provision of one or more specific limited user inputs using the user interface, to directly interact with associated second mode output provided using the user interface in the second mode, the one or more specific limited user inputs not being associated with general unlocking of portable electronic device to enter the first mode of operation.

### TECHNICAL FIELD

The present disclosure relates to the field of portable electronic device modes, associated methods, computer programs and apparatus. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs) and tablet PCs.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Portable electronic devices may enable one or more applications to be opened. Generally, an application allows the user to access functionality of the portable electronic device (e.g. use an email application to write a message for transmittal), identify location related information, connect to another device, or to access information (e.g. use a web browser to read a news website) using the device. When a device is in a fully active mode, the full range of functionality and information provided by the one or more application(s) are generally available to the user (unless there are additional security restrictions associated with a particular applications—even in this case, at least the user would be able to try to get access to the application or be presented with at least some information associated with such an application). If multiple applications are used, a significant amount of processor activity and/or power would be required. Under such a fully active mode therefore, there would not be a restriction on processor activity and/or power usage so that the user can access multiple applications.

In order to lower processor activity and/or power consumption (e.g. to extend battery life) the user may turn off the portable electronic device, or enter a mode wherein user interaction with the portable electronic device is prevented and functionality is disabled (other than allowing the user to return the portable electronic device to the active mode).

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect, there is provided an apparatus comprising:
at least one processor; and
at least one memory including computer program code,
the at least one memory and the computer program code configured to, with the at least one processor, cause the apparatus to perform at least the following:
provide a first mode of operation for a portable electronic device, the first mode configured to allow general unlocked user interaction with the user interface of the portable electronic device, the first mode associated with allowing for the availability of one or more of a first level of power consumption and processor activity for the portable electronic device;
provide a second mode of operation for the portable electronic device, the second mode configured to allow locked user interaction with the user interface of the portable electronic device, the second mode associated with allowing for the availability of one or more of a second level of power consumption or processor activity for the portable electronic device; and
wherein the locked user interaction of the second mode of operation allows for the user to provide one or more specific limited user inputs to the portable electronic device using the user interface of the portable electronic device, to directly interact with associated second mode output provided using the user interface in the second mode of operation, the one or more specific limited user inputs not being associated with general unlocking of portable electronic device to enter the first mode of operation.

A mode of operation of the portable electronic device may be considered to be an operational state of the portable electronic device. For example, the mode of operation may dictate the applications available, the hardware (e.g. keypad, memory, transmitter) which is enabled or disabled, the functionality available (e.g. transmission of data may be enabled in a first mode but not in a second mode), the information available, how the information is presented, and/or how the user can interact with the portable electronic device (e.g. whether an aspect of the user interface, such as a keyboard, is enabled, disabled and/or configured to respond in a different way to the same input). That is, mode of operation may define the behaviour (e.g. default behaviour) and/or capabilities of the portable electronic device (and possible applications running on the portable electronic device). The mode of operation may dictate what information is supplied to the user and/or the functions available to the user.

The second mode may be a user-defined mode of operation (e.g. a mode of operation with user-saved preferences). The mode of operation of the portable electronic device when an application is running in may dictate the behaviour of the application.

The apparatus may be configured to:
in the second mode of operation, provide for the use of a plurality of particular specific limited user inputs, each of the respective plurality of specific limited user inputs associated with a corresponding task performable using the portable electronic device, each task having an associated risk criterion, and wherein the complexity of the specific limited user input corresponds to the risk criterion for the particular task.

The complexity of the specific limited user input may be as a result of one or more of:
the number of interactions with the user interface (e.g. pressing a key multiple times may be more complex than pressing it fewer times);
the number of user interface elements required (e.g. pressing multiple keys may be more complex than pressing one key);
the specificity of the interactions (e.g. interacting with a number of user interface elements in a predetermined sequence may be more complex than interacting with the same interface elements in any order, interacting with a user interface element for a predetermined period of time may be more complex than interacting with the same user interface element for any period of time, interacting with a small area of the user interface may be more complex/require more specificity than interacting with a larger area); and
the complexity of the gesture required to interact with a particular user interface element (e.g. a swipe over a virtual key may be more complex than a single press).

The specific limited user input may comprise one or more of:
pressing a key for at least a predetermined period of time;
pressing a key a predetermined number of times; and
pressing a predetermined sequence of keys.

The task may comprise one or more of:
sending a textual message;
transferring money;
buying an item online;
changing the settings of the electronic device;
initiating a call; and
navigating a menu.

Each task may be associated with a second mode application, the second mode application being available when the portable electronic device is in a second mode of operation. That is, a second mode application may be available to the user (e.g. provide information such as second mode output and/or functionality) when the portable electronic device is configured to be in the second mode of operation. A first mode application may be available to the user (e.g. provide information, output and/or functionality) when the portable electronic device is configured to be in the first mode of operation. Each second mode application may be a first mode application, each first mode application being available when the portable electronic device is in a first mode of operation. An application may be a user application. A user application may be available in the first and second modes of operation.

Each said second mode application may be a first mode application.

The associated second mode output of the selected second mode application may comprise abbreviated output, abbreviated output being an abbreviated version of output available for the selected second mode application when in the first mode. For example, in the case of a map application, just a portion of the information available in the first mode would be available in the second mode. An abbreviated version may be considered to be a reduced version, and/or a redacted version.

The abbreviated output may comprise one or more of:
a subject of a textual message;
a first line of a textual message;
a first predetermined number of characters of a textual message;
information identifying the sender of a textual message;
a news headline;
information detected in, and extracted from a message (e.g. name, address, telephone number);
a direction indicator; and
a location indicator.

Second mode output may be, for example, one or more of: visual output (e.g. image, text); tactile output (e.g. haptic feedback, vibration); and audio output.

The portable electronic device and/or selected second mode application may be configured to continuously provide second mode output (or refresh output at predetermined intervals) when the portable electronic device is in the second mode of operation. For example, if the second mode application were a navigation application or music player application, second mode output may be provided continuously (e.g. information relating to current location, information relating to direction indicator, information relating to current music being played) so that the user can access that information simply by looking at the device.

The portable electronic device and/or selected second mode application may be configured not to continuously provide second mode output when the portable electronic device is configured to be in the second mode of operation. For example, if the second mode application were a blogging application or email (or other messaging) application, second mode output may be provided only in response to an event (e.g. receipt of a message), or to a user interaction with the portable electronic device.

One or more user applications may be available in the first mode of operation, the user applications comprising, for example, two or more of:
a game application;
an email application;
a navigation application (e.g. a satellite navigation application);
a social networking application;
a news feed application;
a web browser; and
a map application.

One or more particular user applications may available as second mode applications.

When in the second mode of operation, the associated second mode output may comprise navigation information associated with a navigation application, and the allowable specific limited user input may include changing the location of the portable electronic device. This may be, for example, as the user moves about with the portable electronic device.

The second mode output may comprise information relating to a received message from a third party and the specific limited user input may enable recording an audio message, and transmitting the recorded message to the third party. Thus, if a message is received, this is still provided to the user in the second mode, and the user is able to easily respond by recording an audio message from the second mode.

The second mode output may comprise information relating to the music file being played and the specific limited user input may enable the user to select a different music file to be played.

The specific limited user input may be limited with respect to the general range of user input available in the first mode. That is, the user input available in the second mode may be a subset of the user input available in the second mode. For example, an example embodiment may have a keyboard user interface and a joystick user interface, wherein in the first mode the user can provide input via both the keyboard user interface and a joystick user interface whereas in the second mode the user can provide input only via the joystick user interface (or even the range of input detectable by the keyboard and/or joystick may be limited in the second mode). In this way, the locked user interaction may be limited with respect to the general unlocked user interaction.

The locked user interaction available in the second mode of operation may be limited with respect to the general unlocked user interaction available in the first mode of operation. The locked user interaction may be a subset of the general unlocked user interaction. The general unlocked interaction may enable the user to interact with all of the applications of the device. The general unlocked interaction may enable the user to access all of the functionality of the device. The locked interaction may prevent the user, in the second mode, from accessing certain applications/functionality (which may be available in the first mode of operation).

The second level of the one or more of power consumption and processor activity may be lower than the first level of the one or more of power consumption and processor activity for the portable electronic apparatus.

The second mode of operation may allow for the user to provide specific limited user input to the portable electronic device using the user interface of the portable electronic device, to directly interact with associated output provided using the user interface in the second mode of operation, whilst keeping the portable electronic device in the second mode.

The apparatus may be configured to provide a third mode of operation for the portable electronic device, the third mode associated with allowing for the availability of one or more of a third level of power consumption or processor activity for the portable electronic device, the third level of one or more of power consumption and processor activity being lower than the second level.

The third mode may provide for a sleep mode in which user input in response to associated output cannot be provided without entering at least one of the first or second modes.

The apparatus may be configured to allow a user interaction to change the mode of the apparatus from one mode to a different mode.

The apparatus may be configured, when in the third mode, to disable user interaction with one or more applications configured to run on the apparatus but allow the user to unlock the portable electronic device to enter the first mode of operation.

The locked user interactions of the second mode may be locked with respect to the availability of one or more of the power source, processor and functionality of the user interface.

The apparatus may be configured to allow a user interaction to move from the third mode to the second mode in response to an event.

An event may comprise:
receipt of a message from a third party; or
an scheduled event.

A received message from a third party may comprise one or more of an SMS, an MMS, a photo message, an image-based message, a video message, an audio message, a social media website-based message, a micro-messaging based message, a web-site based message, a message associated with trading, a website forum-based message, or a hyperlink.

A scheduled event may comprise one or more of:
a calendar entry;
an alarm;
a scheduled software update;
a scheduled anti-virus update; and
a time and date based scheduled update.

A specific limited user input may comprise one or more of:
tilting the portable electronic device;
moving the portable electronic device to a new location (e.g. a new geographic location);
interacting with a touch screen;
pressing a touch screen;
hovering over a touch screen;
touching a particular region of the touch screen;
pressing a key; and
swiping on the touch screen.

Specific limited user input may allow for performance of the task associated with the second mode output, in the second mode.

Specific limited user input may allow for performance of the task associated with the second mode output, in the first mode before automatically returning the portable electronic device to the second mode.

The apparatus may be at least one of a portable electronic device, circuitry for a portable electronic device, a laptop computer, a desktop computer, a mobile phone, a Smartphone, a tablet PC, a monitor, a personal digital assistant or a digital camera or a module for the same.

The portable electronic device having the first and second modes may be considered to be the laptop computer, the desktop computer, the mobile phone, the Smartphone, the tablet PC, the monitor, the personal digital assistant or the digital camera.

The user interface may comprise a combination of one or more of a wand, a pointing stick, a touchpad, a touch-screen, a display, a stylus and pad, a mouse, a physical keyboard, a virtual keyboard, a joystick, a remote controller, a button, a microphone, a motion detector, a position detector, a scriber and an accelerometer.

The apparatus/portable electronic device may comprise a display, and the display may comprise a combination of one or more of an AMOLED (active-matrix organic light-emitting diode), an eInk display, a LCD (liquid crystal display). For example, a display may comprise an underlying eInk screen, and an LCD on top, wherein the LCD may be configured to be transparent or translucent when the eInk screen is in use. When in the second mode, the display may be configured such that it uses less power (e.g. by reducing the colour and/or brightness, and/or changing the colour scheme of the display). For example, a Quarter Video Graphics Array OLED display may consume 3 watts while showing black text on a white background, but only 0.7 watts showing white text on a black background. That is, changing the mode of operation of the portable electronic device may comprise changing the mode of a display of the portable electronic device.

One or more of the second level of power consumption and processor activity for the portable electronic device may be temporarily higher than the first level of power consumption and processor activity for the portable electronic device during processing and/or performance of the specific limited user input and/or the function/task associated with the specific limited user input.

Memory may comprise one or more of, for example, a CD, a DVD, flash memory, a floppy disk, a hard disk, volatile memory, non-volatile memory Random Access Memory.

The apparatus may be connected/connectable to a network. The network may be, for example, the internet, a mobile phone network, a wireless network, LAN or Ethernet. The apparatus may comprise a transmitter and or receiver to interact with a network. The transmitter/receiver may comprise, for example, an antenna, an Ethernet port, a LAN connection, a USB port, a radio antenna, Bluetooth connector, infrared port, or fibre optic detector/transmitter.

It will be appreciated that the second mode may not be an aeroplane or flight mode (e.g. where antenna transmitting and receiving functions are suspended). It will be appreciated that the second mode may not be a low battery mode, the low battery mode being activated in response to detecting that the battery level is below a predetermined threshold. It will be appreciated that the apparatus/portable electronic device may be configured to provide a flight mode and/or a low battery mode in addition to the second mode of operation.

In a second aspect, there is provided a method, the method comprising:
providing/using a first mode of operation for a portable electronic device, the first mode configured to allow general unlocked user interaction with the user interface of the portable electronic device, the first mode associated with allowing for the availability of one or more of a first level of power consumption and processor activity for the portable electronic device;
providing/using a second mode of operation for the portable electronic device, the second mode configured to allow locked user interaction with the user interface of the portable electronic device, the second mode associated with allowing for the availability of one or more of a second level of power consumption or processor activity for the portable electronic device; and
wherein the locked user interaction of the second mode of operation allows for the user to provide one or more specific limited user inputs to the portable electronic device using the user interface of the portable electronic device, to directly interact with associated second mode output provided using the user interface in the second mode of operation, the one or more specific limited user inputs not being associated with general unlocking of portable electronic device to enter the first mode of operation.

In a third aspect, there is provided a computer program comprising computer program code configured to:
provide a first mode of operation for a portable electronic device, the first mode configured to allow general unlocked user interaction with the user interface of the portable electronic device, the first mode associated with allowing for the availability of one or more of a first level of power consumption and processor activity for the portable electronic device;
provide a second mode of operation for the portable electronic device, the second mode configured to allow locked user interaction with the user interface of the portable electronic device, the second mode associated with allowing for the availability of one or more of a second level of power consumption or processor activity for the portable electronic device; and
wherein the locked user interaction of the second mode of operation allows for the user to provide one or more specific limited user inputs to the portable electronic device using the user interface of the portable electronic device, to directly interact with associated second mode output provided using the user interface in the second mode of operation, the one or more specific limited user inputs not being associated with general unlocking of portable electronic device to enter the first mode of operation.

The computer program may be stored on a storage media (e.g. on a CD, a DVD, a memory stick or other non-transitory medium). The computer program may be configured to run on a device or apparatus as an application. An application may be run by a device or apparatus via an operating system.

In a fourth aspect, there is provided an apparatus, the apparatus comprising:
first means of providing configured to provide a first mode of operation for a portable electronic device, the first mode configured to allow general unlocked user interaction with the user interface of the portable electronic device, the first mode associated with allowing for the availability of one or more of a first level of power consumption and processor activity for the portable electronic device;
second means of providing configured to provide a second mode of operation for the portable electronic device, the second mode configured to allow locked user interaction with the user interface of the portable electronic device, the second mode associated with allowing for the availability of one or more of a second level of power consumption or processor activity for the portable electronic device; and
wherein the locked user interaction of the second mode of operation allows for the user to provide one or more specific limited user inputs to the portable electronic device using the user interface of the portable electronic device, to directly interact with associated second mode output provided using the user interface in the second mode of operation, the one or more specific limited user inputs not being associated with general unlocking of portable electronic device to enter the first mode of operation.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 depicts an embodiment comprising a number of electronic components, including memory, a processor and a communication unit.

FIG. 2 illustrates an example embodiment comprising a touch-screen.

FIG. 3a-3g depicts the example embodiment of FIG. 2 wherein a second mode application comprises a calendar application.

FIG. 4a-4f depicts a further example embodiment wherein a second mode application comprises an email application.

FIG. 5 depicts a flow diagram describing the method used to provide a portable electronic device with a first mode of operation and second mode of operation.

FIG. 6 illustrates schematically a computer readable media providing a program according to an example embodiment of the present invention.

### DESCRIPTION OF EXAMPLE ASPECTS/EMBODIMENTS

Other embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

It is common for a portable electronic device to have an active first mode (which may or may not be graphically based) to allow a user to generally interact with the portable electronic device and generally access the (full) functionality of the portable electronic device. For example, in the active mode, the user may be presented with a wide range of icons and options representing different available applications available for general use. Some electronic devices have a second mode (or sleep mode) where the full availability of options are disabled. For these devices the user is either presented, in an active mode, with an interface which allows complete interaction with the portable electronic device and, in the sleep/standby mode, with an interface which inhibits full interaction with the portable electronic device (but allows for unlocking of the device to enter the general mode). Other phones (e.g. Nokia N8) may allow the user to lock and unlock the device (e.g. by using a slider on the side of the phone or by pressing a sequence of keys). In the unlocked mode the user may have general unlocked access to all applications and/or to the full functionality of the phone. In locked mode, the user may be able to receive a phone call, view a screen saver, but user applications and/or functionality are not available.

Example embodiments contained herein may be considered to provide a way of providing a mode of operation with intermediate functionality, information and/or interaction. For example, it may allow the user to access provided functionality, information and/or interaction directly and unambiguously, (e.g. without having to navigate or consider other functionality/information provided in a different mode).

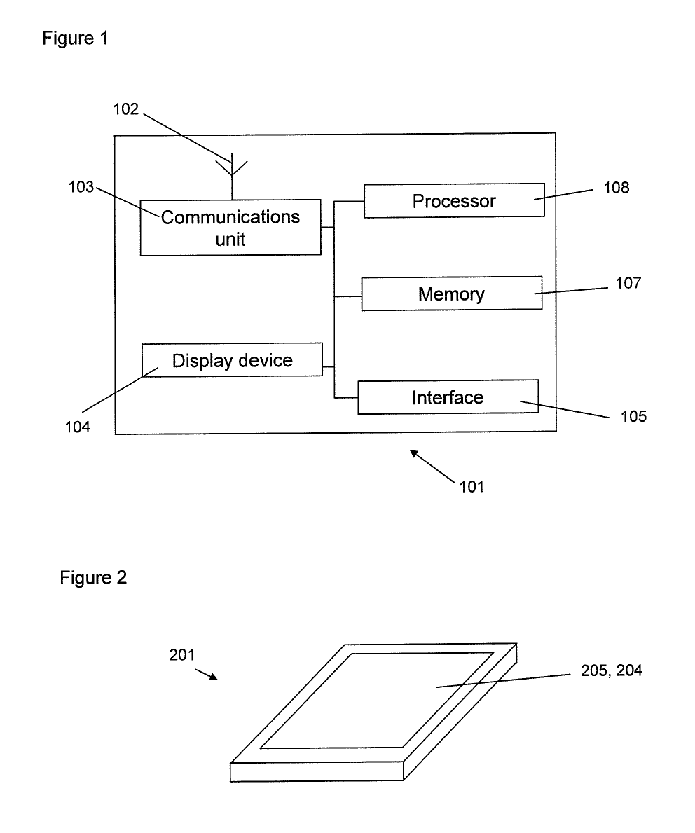

FIG. 1 depicts an apparatus (101) of an example embodiment, such as a mobile phone. In other example embodiments, the apparatus (101) may comprise a module for a mobile phone (or PDA or audio/video player), and may just comprise a suitably configured memory (107) and processor (108).

The example embodiment of FIG. 1, in this case, comprises a display device (104) such as, for example, a Liquid Crystal Display (LCD) or touch-screen user interface. The apparatus (101) of FIG. 1 is configured such that it may receive, include, and/or otherwise access data. For example, this example embodiment (101) comprises a communications unit (103), such as a receiver, transmitter, and/or transceiver, in communication with an antenna (102) for connecting to a wireless network and/or a port (not shown) for accepting a physical connection to a network, such that data may be received via one or more types of networks. This example embodiment comprises a memory (107) that stores data, possibly after being received via antenna (102) or port or after being generated at the user interface (105). The processor (108) may receive data from the user interface (105), from the memory (107), or from the communication unit (103). It will be appreciated that, in certain example embodiments, the display device (104) may incorporate the user interface (105). Regardless of the origin of the data, these data may be outputted to a user of apparatus (101) via the display device (104), and/or any other output devices provided with apparatus. The processor (108) may also store the data for later use in the memory (107). The memory (107) may store computer program code and/or applications which may be used to instruct/enable the processor (108) to perform functions (e.g. read, write, delete, edit or process data).

This example embodiment is configured to enable a plurality of modes of operation, the plurality of modes of operation comprising a first mode of operation and a second mode of operation. The first mode of operation is configured to allow general unlocked user interaction with the user interface (105) of the portable electronic device (101), and is associated with allowing for the availability of one or more of a first level of power consumption and processor (108) activity for the portable electronic device.

The second mode is configured to allow locked user interaction with the user interface (105) of the portable electronic device, and is associated with allowing for the availability of one or more of a second level of power consumption or processor (108) activity for the portable electronic device.

When changing from the first mode of operation to the second mode of operation, the portable electronic device may, for example, be configured to perform one or more of: change the mode of the display device to a low power mode (e.g. by lowering the brightness of the screen (104)); limit the amount of processing activity available; disable part of the user interface (105) (e.g. such that a portion of the touch user interface is not configured to respond to user input); limit the amount of non-persistent memory (107) available (e.g. RAM); disable predetermined hardware (e.g. transmitter, receiver, communications unit (103)); and enable running of applications in a second mode.

The locked user interaction of the second mode of operation allows for the user to provide one or more specific limited user inputs (e.g. limited compared to the general interaction input available in the first mode) to the portable electronic device using the user interface (105) of the portable electronic device, to directly interact with associated second mode output provided using the user interface (105) in the second mode of operation, the one or more specific limited user inputs not being associated with general unlocking of portable electronic device to enter the first mode of operation.

FIG. 2 depicts an example embodiment of the apparatus comprising a portable electronic device (201), e.g. such as a mobile phone, with a user interface comprising a touch-screen user interface (205, 204), a memory (not shown), a processor (not shown) and an antenna (not shown) for transmitting and/or receiving data (e.g. emails, textual messages, phone calls, information corresponding to web pages).

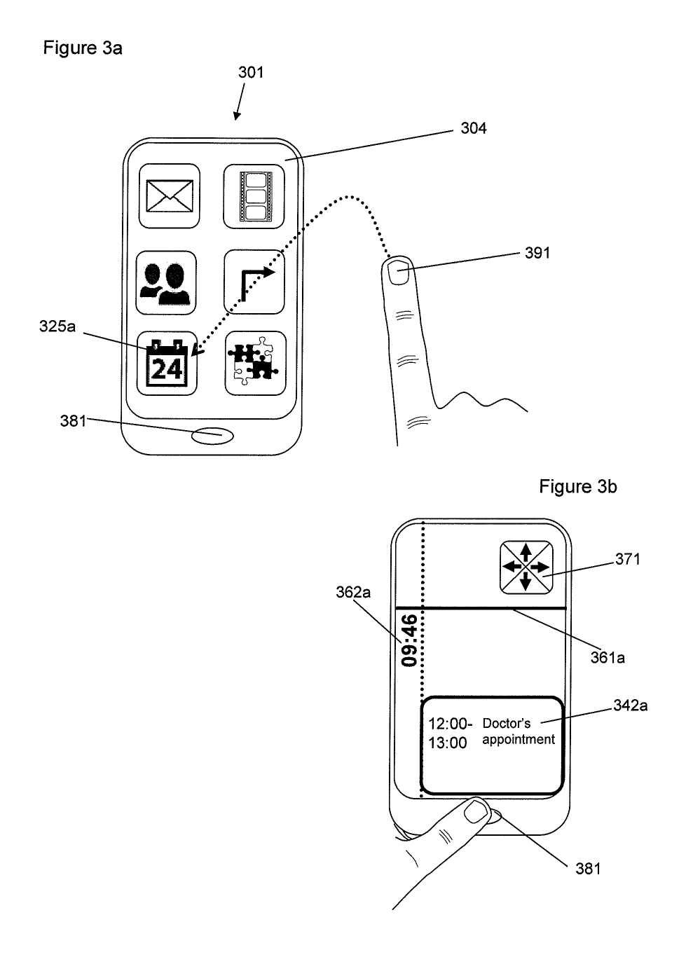

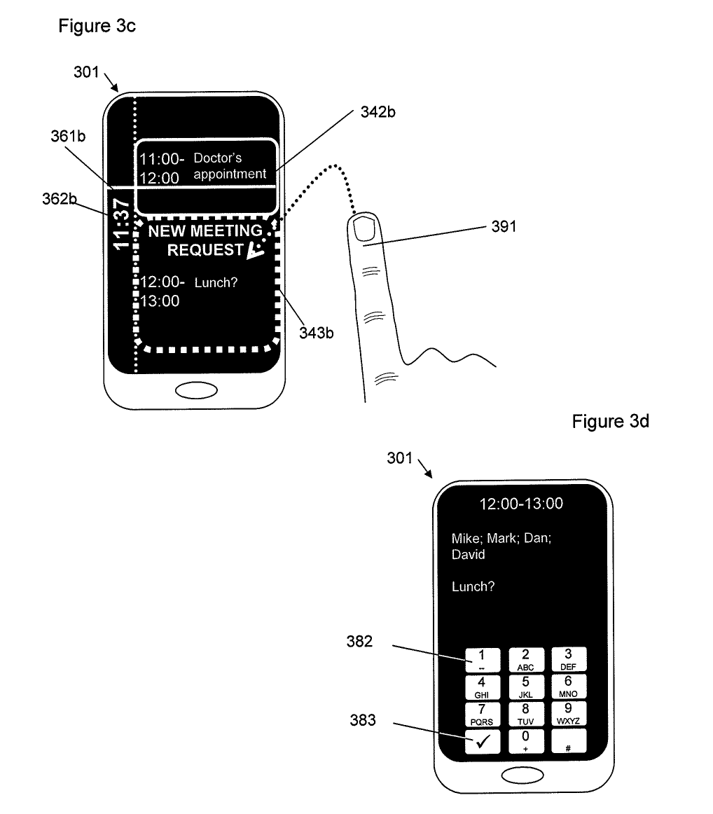

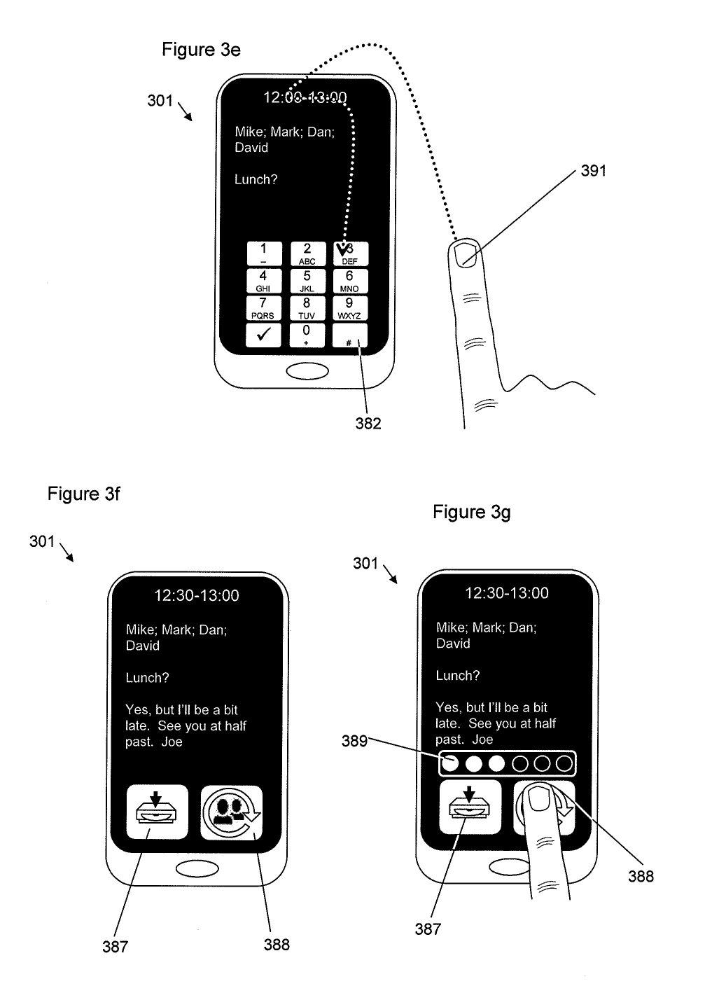

FIG. 3a-f illustrates a series of views of the example embodiment of FIG. 2 which comprises a touch screen (304) (which comprises an OLED screen) configured to display a graphical user interface. In the situation depicted in FIG. 3a the user has just turned on the portable electronic device. The initial screen displayed to the user is the home screen. The home screen comprises a plurality of user interface elements, each user interface element corresponding to an application. The available applications on this example embodiment comprise: an email application, a movie player application, a messaging application, a navigation application, a calendar application, and a settings application.

The portable electronic device is configured to be in a first mode of operation when it is first turned on (as depicted in FIG. 3a). The first mode of operation is configured to allow general unlocked user interaction with the user interface of the portable electronic device, and is associated with allowing for the availability of one or more of a first level of power consumption and processor activity for the portable electronic device. In this example, the user wishes to review what things he has to do that day. He therefore opens the calendar application by selecting the corresponding calendar application user interface element (325a) (e.g. by pressing or hovering over the desired user interface element). This opens the calendar application and displays the information for that day. The current time with respect to the calendar entries is displayed using a horizontal line time indicator (361a) and corresponding clock (362a). The calendar application also provides navigation user interface elements (371). By interacting with the navigation user interface elements (371), the user can look earlier and later in time (by pressing the up and down arrows respectively), and select the previous day or the later day (by pressing the left and right arrows respectively). It will be appreciated that, in the first mode of operation, the user can select a calendar entry (such as the doctor's appointment calendar entry (342a)) and edit the contacts or send an update to the participants corresponding to that calendar entry (e.g. meeting participants).

To enable general unlocked user interaction with the user interface the portable electronic device has, in the first mode, one or more of a first (active) level of power consumption and processor activity available (which would be unrestricted, but not necessarily so e.g. in the case that the device has a further active mode which can provide for a battery life which is double (or extended with respect) the first active mode by, for example, limiting WLAN scanning or the number of background applications which can be run).

When the user has completed reviewing the day's events, he wishes to put the portable electronic device (301) into a second mode in order to preserve battery life. In this case, the user enters the second mode by pressing and holding the physical mode button (381) for a predetermined period of time (depicted in FIG. 3b). This automatically selects the particular running user application (the calendar application in this case) as a selected second mode application such that, when in the second mode of operation, the associated second mode output comprises information associated with the selected second mode application. It will be appreciated that the apparatus may be configured to change the mode of the portable electronic device (e.g. from a first mode to a second mode or vice versa) in response to one or more of: detecting a period of inactivity exceeding a predetermined threshold; a user command (e.g. via a physical or virtual key); or to detecting an event.

FIG. 3c shows the situation when the portable electronic device is in the second mode of operation when the calendar application has been selected as the second mode application. The second mode is configured to allow locked user interaction with the user interface of the portable electronic device, and is associated with allowing for the availability of one or more of a second level of power consumption or processor activity for the portable electronic device. For this embodiment, the screen is placed in a low power mode by configuring the pixels corresponding to the background to be turned off (making them black) and configuring the pixels corresponding to text and user interface elements to be white. This reduces the power consumption of the screen whilst the portable electronic device is on the second mode. It will be appreciated that other example embodiments may be configured to turn all or portions of a screen into a low power mode (e.g. by turning off a backlight, reducing the contrast, selecting colour schemes which reduce power). Such forms of output can be considered to be low power output. Available power consumption and/or processor activity is also restricted by reducing the number of applications which are available to be accessed/run in the second mode.

When in the second mode, the portable electronic device is configured to continuously (or perceived continuously e.g. at predetermined intervals) display and update the second mode output displayed on the screen. In this case the calendar entries (342b) would move with respect to the time indicator (361b) allowing the user to quickly and easily see what would be coming up next. In the second mode, a navigation user interface element is not available to allow the user to view calendar entries for a different day. This may reduce the amount of memory and processor activity required to run the calendar application.

In this example embodiment, the locked user interaction of the second mode of operation allows for the user to provide one or more specific limited user inputs to the portable electronic device using the user interface of the portable electronic device, to directly interact with associated second mode output provided using the user interface in the second mode of operation, the one or more specific limited user inputs not being associated with general unlocking of portable electronic device to enter the first mode of operation.

It will be appreciated that, for this example embodiment, the user is unable to select to view a non-second-mode application, whilst the portable electronic device is in the second mode. That is, the locked interaction available in the second mode is limited with respect to the general unlocked interaction available in the first mode of operation.

In this case, whilst the user is at the doctor's appointment, he receives a new meeting request (343b) from his friends inviting him to lunch. In order to respond quickly, he enters a specific limited user input corresponding to selection of the meeting request using his finger (391) whilst remaining in the second mode of operation. Opening the message in this case is a low-risk task (e.g. as no data is changed and only the user would be affected if the task were performed accidently). In order to perform the low-risk task of opening the received message, the apparatus is configured to require that the user perform a corresponding low-complexity open specific limited user input. To perform the open specific limited user input the user would select the message (343b) (by pressing or hovering with his finger (391) or other stylus). In this example, the open specific user input is not associated with a particular duration of input. That is, the open task can be enabled regardless of the length of the open specific user input. As the risk criterion of the open task is low, the complexity of the open specific limited user input is correspondingly also low. The low complexity of the open specific limited user input is a result of the small number of keystrokes required and the generality of the keystrokes (e.g. no duration of input is stipulated).

This opens the meeting request for editing in an editing window (whilst the portable electronic device remains in the second mode of operation). The editing window comprises a virtual keypad (382) and provides the information supplied by the sender of the request in an editable format. This allows the user to select items of information, and use the keypad (382) to enter characters (using specific limited user inputs) into the selected items of information. In this case, the editing phase of the process has a low risk criterion and correspondingly low complexity specific limited user inputs. In this case, the user wishes to update the time and send a message saying that he will be late. The user first changes the time by selecting the time and editing the selected time by entering o numbers using the keypad keys. This is depicted in FIG. 3c. In the same way the user edits the message.

When the user has completed updating the message, the user presses a complete key (383). The user is then presented with two user interface elements: a save user interface element (387) corresponding to the task of saving a copy of the updated message locally (and not sending information to the sender or to other recipients); and a reply user interface element (388) corresponding to the task of sending the updated message as a reply to the sender of the user meeting request (this is depicted in FIG. 3f). In this case, the task of saving the updated message locally is associated with a low risk criterion (e.g. as only the user may be affected by performing the task accidentally), whilst the task of replying to the sender of the meeting request is associated with a high risk criterion (e.g. as other users may be affected if the task was performed accidentally).

In order to perform the low-risk task of saving a local copy of the user updated message (without sending information to other users such as the sender of the meeting request), the apparatus is configured to require that the user perform a corresponding low-complexity reply specific limited user input. To perform the reply specific limited user input the user would select the save user interface element (387) (by pressing or hovering with his finger (391) or other stylus). In this example, the save specific user input is not associated with a particular duration of input. That is, the save task can be enabled regardless of the length of the save specific user input. As the risk criterion of the save task is low, the complexity of the save specific limited user input is correspondingly low. The low complexity of the save specific limited user input is a result of the small number of keystrokes required and the generality of the keystrokes (e.g. no duration of input is stipulated).

In this case, however, the user wishes to reply to the sender of the meeting request. In order to perform the high-risk reply task of replying to the sender of the meeting request, the apparatus is configured to require that the user perform a corresponding high-complexity reply specific limited user input. In this case the complex reply specific limited user input comprises interacting with the reply user interface element (388) for a period of time within a predetermined time range (e.g. between 3 and 4 seconds). This example embodiment is configured to display, when the user initiates the reply specific user input, a timer user interface element (389) which indicates the duration of the reply specific user input by iteratively illuminating a series of counters. If the user releases his finger when all of the counters are illuminated, the duration of the reply specific limited user input will be within the range required to enable the performance of the reply task.

In this case, the relative complexity of the specific limited user inputs is a result of the additional specificity of the reply specific limited user input (where the duration of the input must be within a certain range) compared with the save specific limited user input (where no duration is specified). It will be appreciated that for other example embodiments more complex specific limited user input require more key presses, more keys, or a more complex sequence of keys.

In this case, the risk criteria are predetermined by the device. It will be appreciated that for other example embodiments, the risk criteria may be user defined. It will be appreciated that for other example embodiments there may be more than two levels of risk.

It will be appreciated that, other example embodiments may be configured to have different colour schemes in different modes of operation. For example a portable electronic device may be configured to, in a first mode, display (e.g. information such as text, map or image) in colour, and, in the second mode, display in black and white. It will be appreciated that whilst in the second mode of operation, the portable electronic device may be configured to change the display (e.g. present an animation or change the colours of the pixels). Changing the configuration of a pixel may extend the life of that pixel (e.g. by preventing the continuous display of one colour creating a permanent artefact (e.g. burn-in or image persistence)).

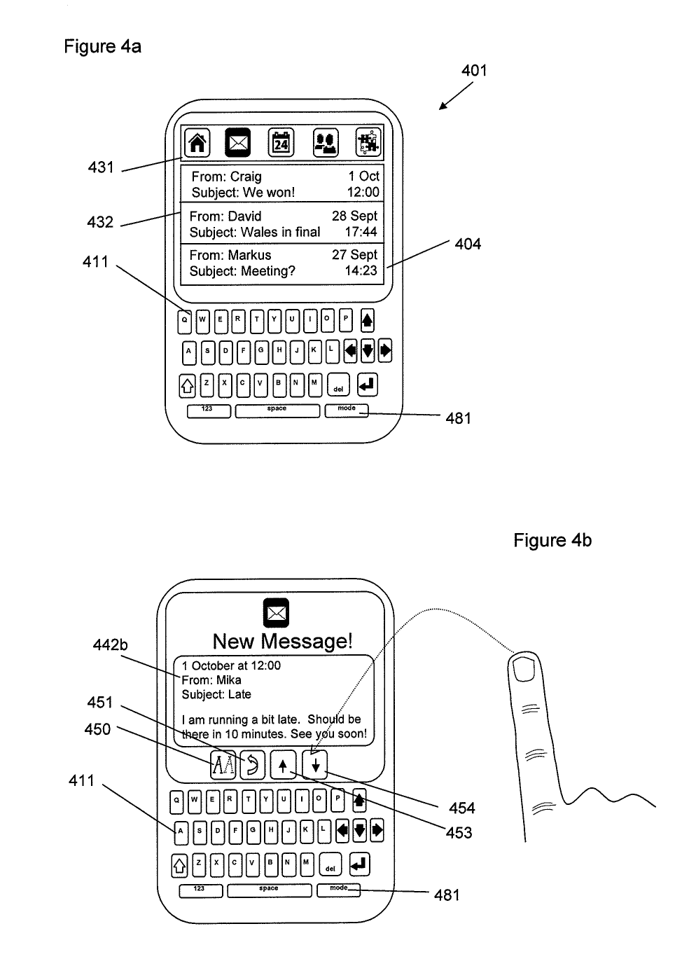

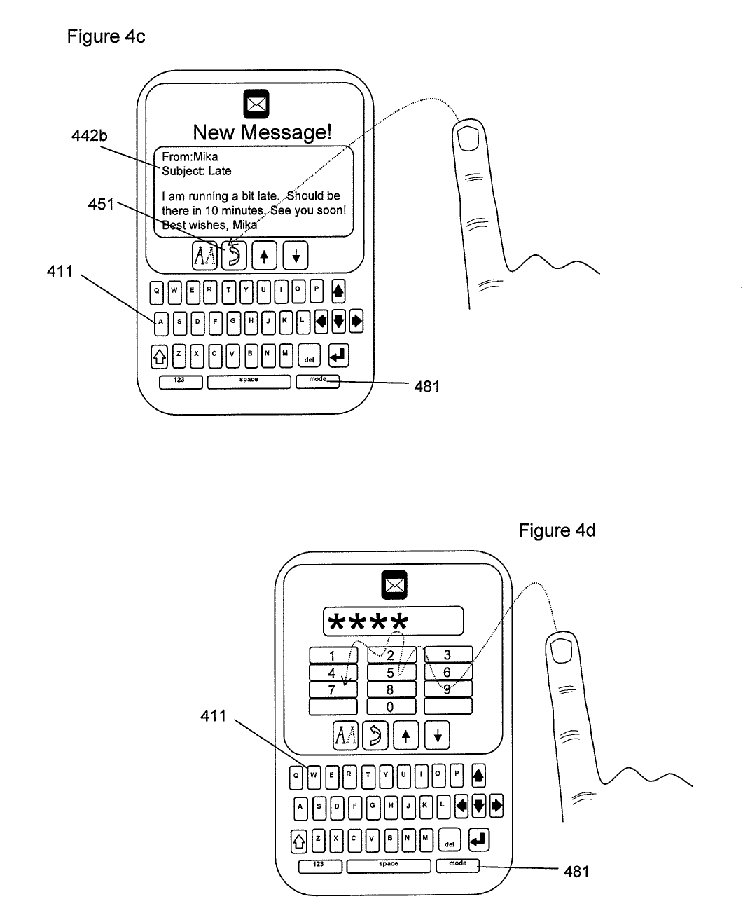

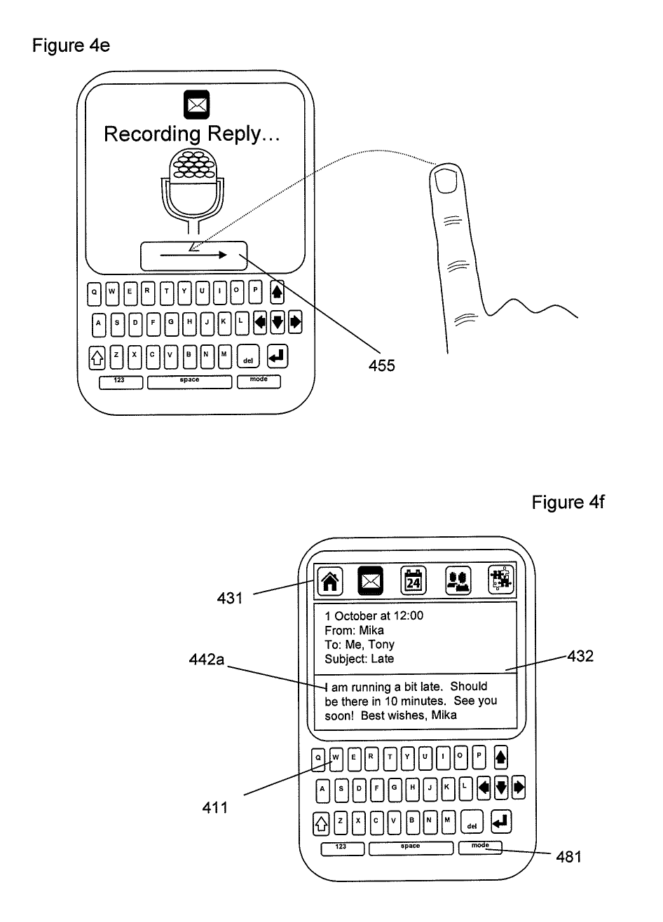

FIG. 4a illustrates a further example embodiment (401) of an apparatus such as a personal digital assistant device comprising a capacitive touch screen (404) configured to display a graphical user interface. This embodiment also comprises a physical key user interface (411) which, in this case, is a virtual QWERTY keyboard. In the situation depicted in FIG. 4a the user has opened an email application whilst in the first (active) mode of the portable electronic device. When the email application is running, the user interface comprises an icon region (431), and an application region (432). The icon region (431) comprises a number of icons: a home icon, configured to allow the user to navigate to a home screen, an email application icon, a calendar application icon, a messaging application icon and a games application icon. The application icons allow the user to navigate to the corresponding respective application provided by the portable electronic device.

The first (active) mode, in this case, allows for general unlocked user interaction with the user interface of the portable electronic device. That is, the user can interact with the portable electronic device by interacting with the touch screen and/or the physical key user interface. In this case, the first mode is associated with allowing for the availability of one or more of a first level of power consumption and processor activity for the portable electronic device. In this case, the screen brightness is configured to be a first brightness when the portable electronic device is in a first mode of operation.

In the situation depicted in FIG. 4a, the email application is running. The email application region (432) in this case gives a list or recently received emails. In this case, the user has finished reviewing his recently received messages and wishes to put the phone/portable electronic device (401) in his pocket. In order to, for example, save battery life and to reduce the risk of unwanted key presses in his pocket, the user changes the mode of the portable electronic device to a second (standby) mode (e.g. by pressing a mode key (481)). Pressing the mode key (481) to change the mode of the portable electronic device to the second mode selects the currently active application as the selected second mode application. It will be appreciated that, to select a different available application from the plurality of available applications (e.g. calendar application, messaging application), the user would make that application the active application before changing the mode of the portable electronic device. It will be appreciated that for other example embodiments, the apparatus may be configured to change the mode of the electronic device automatically, for example, after detecting a predetermined period of inactivity. A default application may be preselected for use in the second mode (rather than the last application used). It will be appreciated that the user may actively select which application or applications are available in the second mode (e.g. by selecting second mode applications from a list of user applications).

The second (standby) mode of operation is configured to allow locked user interaction with the user interface of the portable electronic device. In this case, the physical key user interface (411) is deactivated (apart from to allow the mode of the device to be changed), whereas one or more specific limited user inputs may be input via the touch screen user interface to directly interact with the associated second mode output. That is the locked user interaction available in the second mode is limited compared to the general unlocked user interaction available in the first mode as the user can interact with the portable electronic device via the physical key user interface (411) or the touch screen user interface (404) in the first mode but only via the touch screen user interface (404) in the second mode (or even just parts of the touch screen user interface (404) in the second mode). In this case, the second mode email application is configured not to continuously provide second mode output when the portable electronic device is configured to be in the second mode of operation. That is, in this case, the second mode email application is configured to provide second mode output only in response to an event (e.g. the reception of a message).

In the situation depicted in FIG. 4b, the portable electronic device has received a new message whilst in the second mode of operation, in this case, from a third party. Information relating to the message (442b) is displayed on the touch screen as second mode output. In this case, the second mode output is abbreviated second mode output, as the second mode output is an abbreviated (e.g. redacted) version of the output available in the first mode of operation. In this case, the abbreviated second (standby) mode output (442b) comprises the date and time of the message (although this could be omitted), the sender of the message, the subject of the message, and the content of the message. A selection of these details could be omitted. By providing abbreviated output, the user can quickly and easily see important details of the message without having to change the mode of the portable electronic device. It will be appreciated that for other example embodiments/applications the second mode output may not be abbreviated second mode output (i.e. if all of the information available in the first mode were available in the second mode).

In this case the apparatus is configured, in the second mode, to allow for the user to provide one or more specific limited user inputs to the portable electronic device using the touch screen user interface (404) of the portable electronic device (401), to directly interact with associated abbreviated message second mode output (442b) provided using the user interface in the second mode of operation, the one or more specific limited user inputs not being associated with general unlocking of portable electronic device to enter the first mode of operation.

In order to interact with the received message, in this case, the user is presented with four user interface elements (depicted in FIG. 4b): a hide user interface element (450) corresponding to the task of hiding the received message; a reply user interface element (451) corresponding to the task of replying to the sender of the received message; a up-scroll user interface element (452) corresponding to the task of scrolling up through the received message; and a down-scroll user interface element (453) corresponding to the task of scrolling down through the received message.

In this case the risk criteria associated with the tasks are on a five-level scale, 5 being high risk and 1 being low risk. In this case, the tasks of scrolling up and scrolling down through the received message is associated with a risk criterion of 1 (e.g. corresponding to low risk as no data would be affected by performing the task accidentally), the task of hiding the received message is associated with a risk criterion of 3 (e.g. corresponding to medium risk as data would not be lost but would no longer be immediately apparent to the user), and the task of replying to the sender of the received message is associated with a risk criterion of 5 (e.g. corresponding to high risk as data would be transmitted from the device).

In this case, the user wishes to scroll down the received message. In order to perform the level-1 risk reply task of scrolling down to the sender of the meeting request, the apparatus is configured to require that the user perform a corresponding level-1 complexity scroll down specific limited user input. To perform the scroll down specific limited user input the user would select the scroll down user interface element (453), as shown in FIG. 4b (by pressing or hovering with his finger (491) or other stylus). In this example, the scroll down specific user input is not associated with a particular duration of input. That is, the scroll down task can be enabled regardless of the length of the save specific user input. As the risk criterion of the scroll task is level 1, the complexity of the scroll down specific limited user input is correspondingly level 1. The low complexity of the scroll down specific limited user input is a result of the small number of keystrokes required and the generality of the keystrokes (e.g. no duration of input is stipulated).

Had the user wished to perform the task of scrolling up, the apparatus would have required the user to perform a corresponding level-1 complexity scroll up specific limited user input. Like the scroll down specific limited user input, the scroll up specific limited user input is a single selection which is not associated with a particular duration (corresponding to level 1 complexity).

After having scrolled down and read the entire received message, the user wishes to reply to the sender of the meeting request. In order to perform the level-5 risk reply task of replying to the sender of the meeting request, the apparatus is configured require that the user performs a corresponding level-5 complexity reply specific limited user input. In this case the level-5 complexity reply specific limited user input comprises selecting the reply user interface element (451) (depicted in FIG. 4c) that initiates the display of a virtual numeric keypad (depicted in FIG. 4d). The user must then enter a predetermined four-digit PIN (Personal Identification Number) to enable the performance of the reply task. As the risk criterion of the reply task is level 5, the complexity of the reply specific limited user input is correspondingly level 5. The high complexity of the reply specific limited user input is a result of the large number of keystrokes required and the specificity of the keystrokes (e.g. the correct PIN sequence must be entered). When the correct PIN has been entered the apparatus is configured to initiate the recordal of an audio message (depicted in FIG. 4e). When the user has completed his message, he can send the message by pressing the confirm send user interface element (455).

For this example embodiment, had the user wished to perform the level-3 risk reply task of hiding the received message, the apparatus would have required that the user performs a corresponding level-3 complexity hide specific limited user input. In this case the level-3 complexity hide specific limited user input comprises selecting the reply user interface element (450) for a period of time within a predetermined range (e.g. between 2 and 3 seconds). The medium complexity of the hide specific limited user input is a result of the small number of keystrokes required and the specificity of the keystrokes (e.g. the input must be of the correct duration).

In this case, the relative complexity of the specific limited user inputs is a result of the specificity and the number of keystrokes of the specific limited user inputs. The more specific the key strokes, the more complex are the specific limited user inputs; the less specific the key strokes, the less complex are the specific limited user inputs. The more numerous the key strokes, the more complex are the specific limited user inputs; the less numerous the key strokes, the less complex are the specific limited user inputs.

It will be appreciated that the risk criteria assigned to a task may be based on a combination of one or more of: whether there is a financial transaction; how data is processed (e.g. deleting data may be higher risk than reading data); and who is affected by the task (e.g. sending a message to a third party may have a higher risk than saving a local copy).

It will be appreciated that allowing lower risk tasks to be enabled by lower complexity specific limited user inputs may allow a more intuitive user interface. It will be appreciated that allowing higher risk tasks to be enabled by higher complexity specific limited user inputs may provide protection against performing tasks accidently. This may be particularly important for low power modes, as the portable electronic device may not have the full attention of the user (e.g. in the case of a phone it may be in the user's pocket).

In this case, the risk criteria are predetermined by the device. It will be appreciated that for other example embodiments, the risk criteria may be user defined. For example, a user may wish to associate a higher risk criteria to sending an email to his boss than to his friends.

After the message has been sent, in this example, the user wishes to review the full received message. In order to do this, the user enters the first (active) mode by manually pressing the mode key (481) for a predetermined period of time. It will be appreciated that other example embodiments may require multiple key strokes or an interaction with multiple keys to switch between modes of operation. When in the first (active) mode, the user can open the recently received message within the email application. This is shown in FIG. 4d. In the first mode, the portable electronic device is configured to enable display of all of the first mode output. In this case the first mode output (442a) comprises the other recipients of the message in addition to the information available in the second mode, such as, the date and time of the message, the sender of the message, the subject of the message, and the content of the message. When in the first mode, additional interactions are available compared to the interactions available in the second mode. In the first mode, this example embodiment is configured to allow the user to, for example, forward the message to another user, reply to the sender via a textual message, delete the received message, save the received message, and/or mark the received message as important.

It will be appreciated that other example embodiments may have further modes of operation in addition to the first and second modes of operation. For example, an example embodiment may have a third mode (e.g. a simple background mode) wherein all of the user interactions with the portable electronic device are disabled except those which enable the portable electronic device to be changed from the third mode into another mode (e.g. the first mode or the second mode). It will be appreciated that, when in a third mode, the portable electronic device may be configured to change into a second mode in response to an event (e.g. in response to receiving a message, or a scheduled calendar event).

It will be appreciated that, by providing the user with a second mode which allows only specific limited user inputs, the user may interact with the device more intuitively and easily in the second mode. In addition, it may prevent the user from making unwanted or accidental interactions with the portable electronic device whilst retaining useful functionality. It may also allow the battery life of the portable electronic device to be extended. For example, if the user wishes to perform a simple task using the device he may not need to activate the full functionality of the device to do so.

For this embodiment, the messaging application also displays abbreviated second mode output when the portable electronic device is configured to be in the second mode of operation. For example, in the second mode, the application is configured to display only sender information and the first sentence of a message. Furthermore, this example embodiment is configured such that the messaging application only displays second mode output in response to an event (e.g. when a message is received). Like the email application described above, the messaging application also allows specific user input to allow the user to quickly reply the sender of a message whilst remaining in the second mode of operation.

It will be appreciated that other example embodiments may or may not enable the reception of calls (e.g. telephone calls) whilst in the second mode. For example, an example embodiment may, in response to receiving a call, automatically change the mode of the device into the first mode from the second mode. In the first mode, the apparatus would enable general unlocked interaction with the portable electronic device for example, to accept/reject the call and interact with other applications apart from the call application, at least while the call was active. The device may then automatically return the device to the second mode upon the call being finished/rejected. Another example embodiment may enable the reception/acceptance of calls whilst remaining in the second mode of operation and thus not allow general interaction (e.g. with other applications apart from the call application) while the call is active.

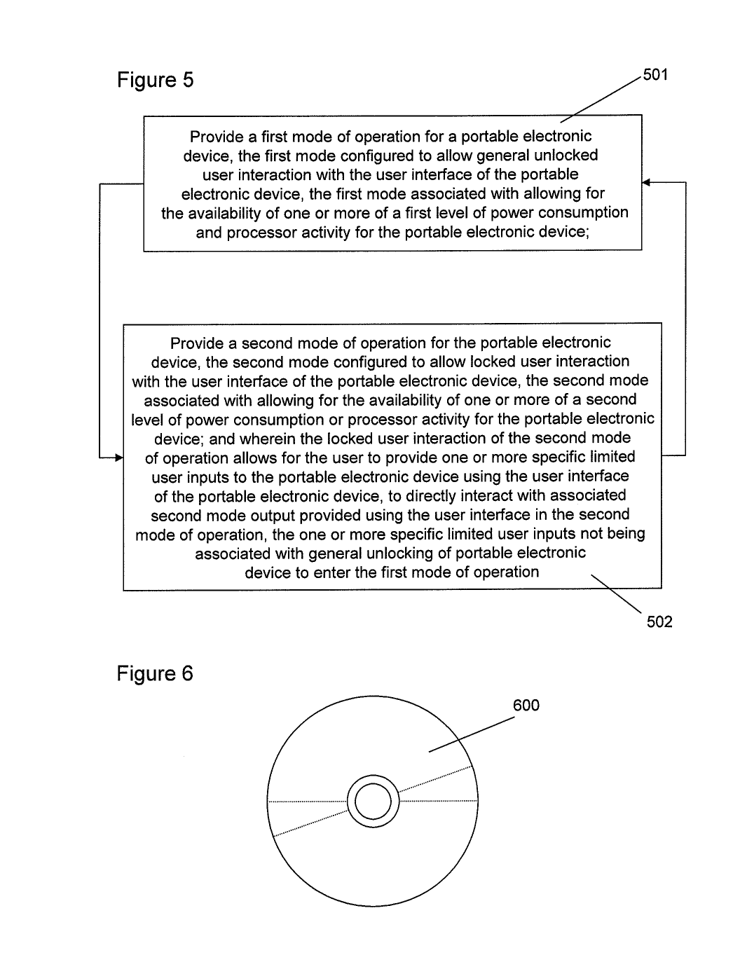

FIG. 5 shows a flow diagram illustrating the operation of different modes of the portable electronic device, and is self-explanatory.

FIG. 6 illustrates schematically a computer/processor readable media 600 providing a program according to an embodiment of the present invention. In this example, the computer/processor readable media is a disc such as a digital versatile disc (DVD) or a compact disc (CD). In other embodiments, the computer readable media may be any media that has been programmed in such a way as to carry out an inventive function.

It will be appreciated to the skilled reader that any mentioned apparatus/device and/or other features of particular mentioned apparatus/device may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” or processor described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features of the invention as applied to preferred embodiments thereof, it will be understood that various omissions and substitutions and changes in the form and details of the portable electronic devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
provide a first mode of operation for a portable electronic device, the first mode configured to allow general unlocked user interaction with the user interface of the portable electronic device, the first mode associated with allowing for the availability of one or more of a first level of power consumption and processor activity for the portable electronic device; and
provide a second mode of operation for the portable electronic device, the second mode configured to allow locked user interaction with the user interface of the portable electronic device, the second mode associated with allowing for the availability of one or more of a second level of power consumption or processor activity for the portable electronic device,
wherein the locked user interaction of the second mode of operation allows for the user to provide a plurality of specific limited user inputs to the portable electronic device using the user interface of the portable electronic device, to directly interact with associated second mode output provided using the user interface in the second mode of operation, each of the plurality of specific limited user inputs
not being associated with general unlocking of portable electronic device to enter the first mode of operation, and
being associated with a corresponding task performable using the portable electronic device in the second mode of operation, each task having an associated risk criterion, and wherein the complexity of the specific limited user input corresponds to the risk criterion for the particular task.

2. (canceled)

3. The apparatus of claim 1, wherein the specific limited user input comprises one or more of:
pressing a key for at least a predetermined period of time;
pressing a key a predetermined number of times; and
pressing a predetermined sequence of keys.

4. The apparatus of claim 1, wherein the task comprises one or more of:
sending a textual message;
transferring money;
buying an item online;
changing the settings of the electronic device;
initiating a call; and
navigating a menu.

5. The apparatus of claim 1, wherein a said task is associated with a user application, the user application being available in the first and second modes of operation.

6. The apparatus of claim 1, wherein second mode output is abbreviated mode output, abbreviated mode output being an abbreviated version of the output available in the first mode.

7. The apparatus of claim 6, wherein the abbreviated output comprises one or more of:
a subject of a textual message;
a first line of a textual message;
information identifying the sender of a textual message;
a news headline;
a direction indicator; and
a location indicator.

8. The apparatus of claim 5, wherein a said application comprises one or more of:
an email application;
a navigation application;
a social networking application;
a news feed application;
a web browser; and
a map application.

9. The apparatus of claim 1, wherein, when in the second mode of operation, the second mode output comprises one or more of:
navigation information associated with a navigation application, and the allowable specific limited user input includes changing the location of the portable electronic device;
information relating to a received message from a third party and the specific limited user input enables recording an audio message, and transmitting the recorded message to the third party; and
information relating to the music file being played and the specific limited user input enables the user to select a different music file to be played.

10. The apparatus of claim 1, wherein the specific limited user input is limited with respect to the general range of user input available in the first mode.

11. The apparatus of claim 1, wherein the second mode output is a low power output with respect to the output available in the first mode of operation.

12. The apparatus of claim 1, wherein the second level of the one or more of power consumption and processor activity is lower than the first level of the one or more of power consumption and processor activity for the portable electronic apparatus.

13. The apparatus of claim 1 wherein the second mode of operation allows for the user to provide specific limited user input to the portable electronic device using the user interface of the portable electronic device, to directly interact with associated output provided using the user interface in the second mode of operation, whilst keeping the portable electronic device in the second mode.

14. The apparatus of claim 1, the apparatus configured to provide a third mode of operation for the portable electronic device, the third mode associated with allowing for the availability of one or more of a third level of power consumption or processor activity for the portable electronic device, the third level of one or more of power consumption and processor activity being lower than the second level.

15. The apparatus of claim 1, wherein the locked user interactions of the second mode are locked with respect to the availability of one or more of the power source, processor and functionality of the user interface.

16. The apparatus of claim 1 wherein one or more of the second level of power consumption and processor activity for the portable electronic device are temporarily higher than the first level of power consumption and processor activity for the portable electronic device during processing and/or performance of the specific limited user input and/or the task associated with the specific limited user input.

17. The apparatus of claim 1, wherein a specific limited user input comprises:
tilting the portable electronic device;
moving the portable electronic device to a new location;
interacting with a touch screen;
pressing a touch screen;
hovering over a touch screen;
touching a particular region of the touch screen;
pressing a key; and
swiping on the touch screen.

18. The apparatus according to claim 1, wherein the apparatus is at least one of a portable electronic device, circuitry for a portable electronic device, a laptop computer, a desktop computer, a mobile phone, a Smartphone, a tablet PC, a monitor, a personal digital assistant or a digital camera or a module for the same.

19. A method, the method comprising:
providing a first mode of operation for a portable electronic device, the first mode configured to allow general unlocked user interaction with the user interface of the portable electronic device, the first mode associated with allowing for the availability of one or more of a first level of power consumption and processor activity for the portable electronic device;
providing a second mode of operation for the portable electronic device, the second mode configured to allow locked user interaction with the user interface of the portable electronic device, the second mode associated with allowing for the availability of one or more of a second level of power consumption or processor activity for the portable electronic device; and
wherein the locked user interaction of the second mode of operation allows for the user to provide a plurality of specific limited user inputs to the portable electronic device using the user interface of the portable electronic device, to directly interact with associated second mode output provided using the user interface in the second mode of operation, each of the plurality of specific limited user inputs
not being associated with general unlocking of portable electronic device to enter the first mode of operation, and
being associated with a corresponding task performable using the portable electronic device in the second mode of operation, each task having an associated risk criterion, and wherein the complexity of the specific limited user input corresponds to the risk criterion for the particular task.

20. A computer-readable non-transitory medium comprising computer program code configured to:
provide a first mode of operation for a portable electronic device, the first mode configured to allow general unlocked user interaction with the user interface of the portable electronic device, the first mode associated with allowing for the availability of one or more of a first level of power consumption and processor activity for the portable electronic device;
provide a second mode of operation for the portable electronic device, the second mode configured to allow locked user interaction with the user interface of the portable electronic device, the second mode associated with allowing for the availability of one or more of a second level of power consumption or processor activity for the portable electronic device; and
wherein the locked user interaction of the second mode of operation allows for the user to provide a plurality of specific limited user inputs to the portable electronic device using the user interface of the portable electronic device, to directly interact with associated second mode output provided using the user interface in the second mode of operation, each of the plurality of specific limited user inputs
not being associated with general unlocking of portable electronic device to enter the first mode of operation, and
being associated with a corresponding task performable using the portable electronic device in the second mode of operation, each task having an associated risk criterion, and wherein the complexity of the specific limited user input corresponds to the risk criterion for the particular task.
